(19) United States
(12) Patent Application Publication
(10) Pub. No.: US 2011/0301848 A1
(43) Pub. Date: Dec. 8, 2011

(54) METHOD OF DIAGNOSING FLOW AND DETERMINING COMPOSITIONAL CHANGES OF FLUID PRODUCING OR INJECTING THROUGH AN INFLOW CONTROL DEVICE

(75) Inventors: Gonzalo A. Garcia, Katy, TX (US); Luis A. Garcia, Houston, TX (US); Xiaowei Wang, Houston, TX (US)

(73) Assignee: BAKER HUGHES INCORPORATED, Houston, TX (US)

(21) Appl. No.: 12/796,131

(22) Filed: Jun. 8, 2010

(51) Int. Cl. G01F 1/68; G01N 25/00; G06F 19/00

(52) U.S. Cl. 702/6; 73/204.11; 73/61.76; 73/54.42

(57) ABSTRACT

A method of diagnosing flow through an inflow control device includes, producing or injecting fluid through an inflow control device, measuring temperatures near or at the inflow control device over time while producing or injecting fluid therethrough, and attributing temporal changes in temperature to changes in the fluid that is produced or injected.

### BACKGROUND

During the production or injection life of a borehole in an earth formation in the completion industry, for example, it is expected that borehole and formation conditions can change over time and that these changes can alter production or injection. Examples of such changes include increases and decreases in fluid flow rates created by changes in the formation and/or changes in fluid composition (Fluid composition here being defined as relative percentages of gas, oil and water and changes in fluid composition referring to changes in the relative percentages). Different zones along the borehole often change at different times. Changes in one zone can negatively affect production or injection of that zone, of other zones, and of the borehole as a whole. Knowing when changes occur and how such changes affect production or injection through each inflow control device can allow an operator to make changes that could increase overall production or injection of the borehole. Unfortunately, gathering such knowledge can be expensive since it typically includes halting production or injection and running logging tools into the borehole to capture data sufficient to determine what changes in fluid flow rates and fluid composition at different inlet zones has occurred. Methods that permit an operator to gain such knowledge without intervention would be well received in the industry.

### BRIEF DESCRIPTION

Disclosed herein is a method of diagnosing flow through an inflow control device. The method includes, producing or injecting fluid through an inflow control device, measuring temperatures near or at the inflow control device over time while producing or injecting fluid therethrough, and attributing temporal changes in temperature to changes in the fluid that is produced or injected.

Further disclosed herein is a method of determining compositional changes of a fluid flowing through an inflow control device. The method includes, measuring temperatures at selected points relative to the inflow control device at a first time, measuring temperatures at the selected points relative to the inflow control device at a second time, determining differences in temperature at the selected points between the first time and the second time, and attributing temporal temperature differences at the selected points to changes in composition of the fluid flowing.

### BRIEF DESCRIPTION OF THE DRAWINGS

The following descriptions should not be considered limiting in any way. With reference to the accompanying drawings, like elements are numbered alike:

FIG. 1 depicts a schematic representation of a portion of a downhole completion application wherein methods disclosed herein are deployed;

FIG. 2 depicts relationships between pressure, temperature and flow rates through various flow devices;

FIG. 3 depicts a flow chart of a process disclosed herein to calibrate a mathematical model to a simulator; and

FIG. 4 depicts a flow chart of a process disclosed herein to diagnose a completion operation through comparison to a mathematical model or a simulator.

### DETAILED DESCRIPTION

A detailed description of one or more embodiments of the disclosed apparatus and method are presented herein by way of exemplification and not limitation with reference to the Figures.

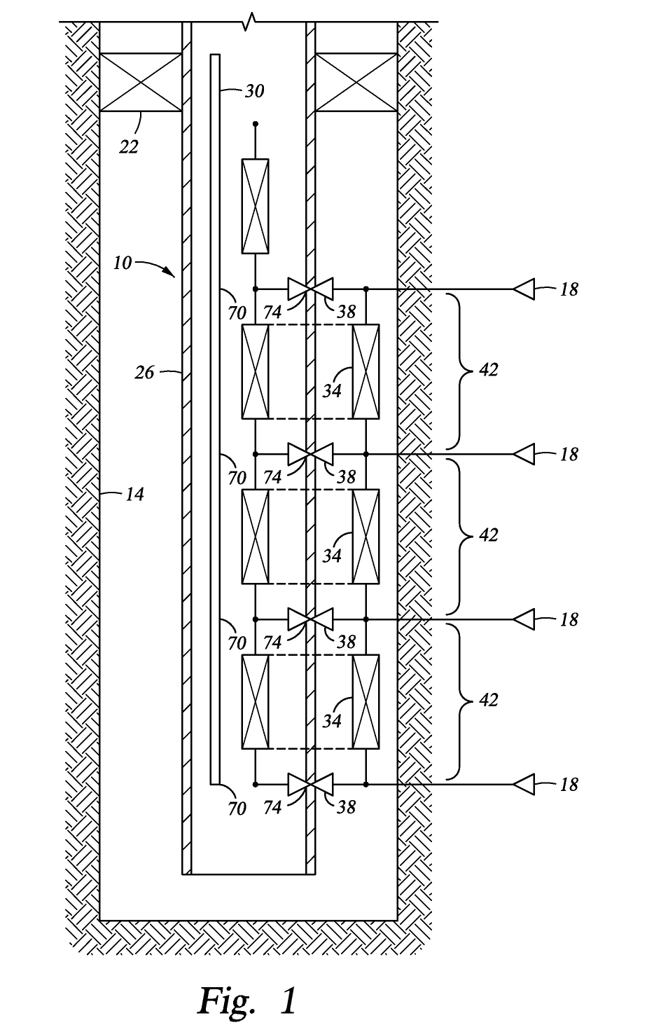

Referring to FIG. 1, a completion liner 10 as illustrated is positioned within a borehole 14 of an earth formation 18 in a downhole completion operation. The completion liner 10 is sealably engaged to the borehole 14 via a packer 22. The completion liner 10 includes a basepipe 26 with a distributed temperature sensor (DTS) 30, or multiple discrete sensors, positioned, inside or outside the basepipe 26, to monitor temperature therealong in real time either upstream or downstream of a plurality of inflow control devices (ICD) 34. The plurality of inflow control devices 34, with three being illustrated in this embodiment, are longitudinally spaced along the basepipe 26 with a node 38 being positioned to either longitudinal side of each of the ICDs 34 thereby designating separation of adjacent zones 42. Flow rates from various positions along the formation 18 through each of the ICDs 34 can depend upon various factors. For example, permeability of the formation 18 can vary at different positions as well as the ratio of oil to water to gas from each zone 42. It should be understood, that although examples disclosed herein are directed to production through the drill string 10, alternate embodiments could just as well be directed to injecting fluids through the completion liner 10, out through the ICDs 34 and into the formation 18.

Although inflow control devices 34 can help to balance production from the various zones 42 along the completion liner 10, it may be desirable for an operator to alter production through particular zones 42 even further than what is possible through the ICDs 34. For example, if one of the zones 42 is producing mostly water, it may be desirable to fully close off production from that zone 42. Additionally, if a zone 42 is producing too fast, partially closing the zone 42 can minimize erosion of the ICD 34 thereby extending the life of the ICD 34 and likely increasing total production from the well in the process.

Knowing when to make alterations, however, requires knowledge of what is happening at the various zones 42. Typically this has meant running logging tools within the completion liner 10 to take measurements therealong. Such intervention, however, is costly in terms of labor, equipment and lost production. Consequently, these interventions are used sparingly, possibly resulting in delays that could, if implemented sooner, have had significant benefits to the operation, including increasing production therefrom. Embodiments disclosed herein allow an operator to gain knowledge regarding flow through the ICDs 34, positioned along the completion liner 10, without interfering with production therethrough.

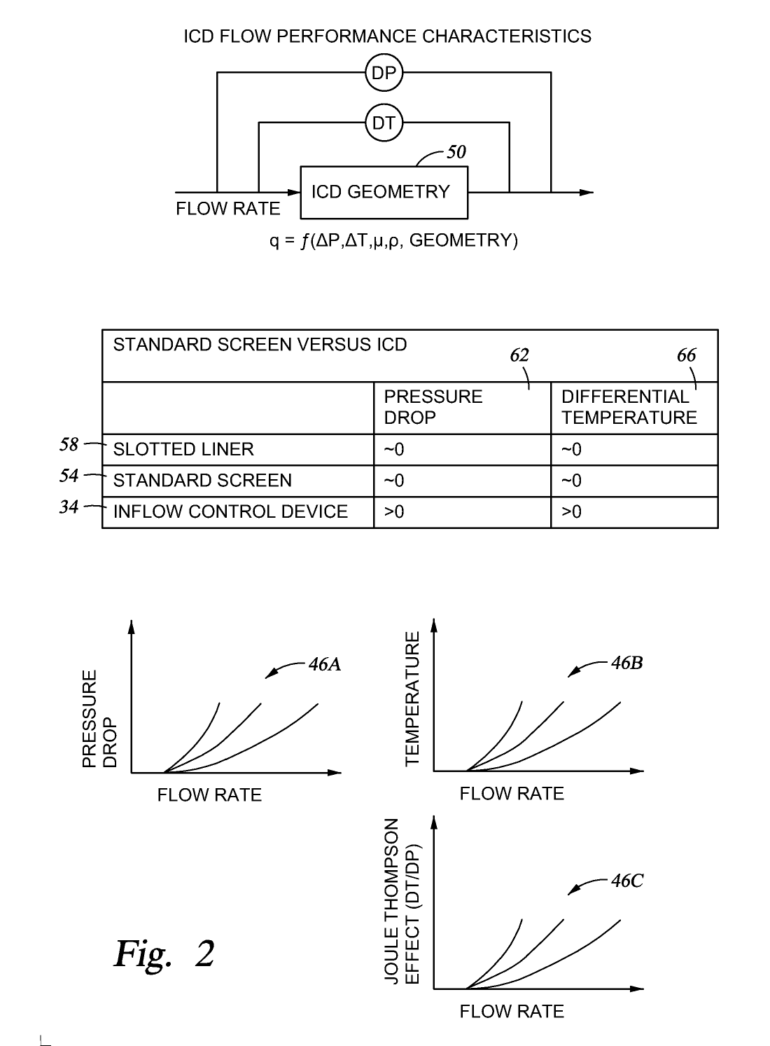

Referring to FIG. 2, embodiments disclosed herein build on the fact that specifics of geometry 50 of the ICDs 34 determine flow performance characteristics 46A, 46B and 46C therethrough. For example, the Joule Thompson effect 46C (change in temperature divided by change in pressure) is a function of the geometry 50 of the ICD 34 and flow rates for any particular fluid having specific fluid properties, such as density and viscosity. Geometry of standard screens 54 and slotted liners 58, by contrast, do not have pressure drops 62 or cause differential temperatures 66 that could be employed in the techniques disclosed herein.

Since flow performance characteristics of pressure drop versus flow rate 46A, temperature differential versus flow rate 46B and Joule Thompson Effect versus flow rate 46C are determined by the geometry 50 of the ICD 34 for a specific fluid these flow performance characteristics 46A, 46B, 46C can be both empirically mapped and mathematically calculated. Mapping them may entail measuring actual temperatures at selected points 70, downstream and upstream of ICDs 34, and actual pressures at selected locations 74, along the completion liner 10 while flowing fluids of known ratios of oil to water to gas at known flow rates. The density and viscosity of these fluids, being a function of the oil to water to gas ratio, is also known and is included in the mapping database. By taking such measurements at a variety of different fluids and flow rates the flow performance characteristics 46A, 46B, 46C can be accurately mapped.

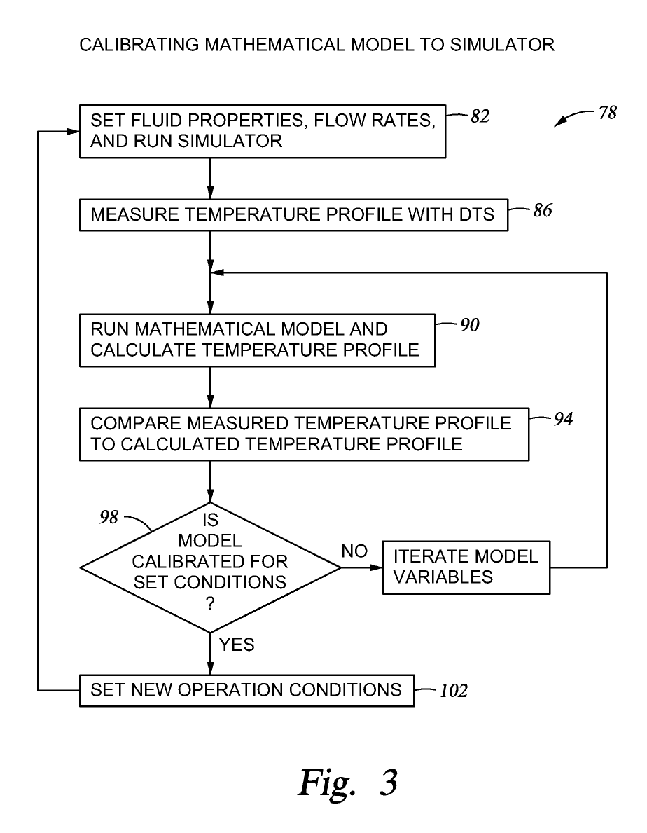

Referring to FIG. 3, a process for calibrating the mathematical model to a simulator is shown in flow chart 78. Schematically, the simulator is configured similar to the completion configuration of FIG. 1, the primary difference being that parameters affecting flow through each of the zones 42 of the simulator are controllable and selectable. As discussed, these parameters, among other things, include, fluid ratios of oil to water to gas, fluid viscosity, fluid density and flow rate. The mathematical model includes adjustable variables that when properly calibrated will accurately calculate temperature profiles that strongly correlate with temperature profiles measured. The model is based on mass, momentum and energy equations including Joule Thompson Effect equations.

In a first step 82 of the flow chart 78, the simulator is run with selected fluid properties and selected flow rates. A temperature profile is measured with the DTS 30 in the second step 86. In a third step 90 the mathematical model is run and a temperature profile is calculated. The fourth step 94 involves comparing the measured temperature profile to the calculated temperature profile. In the fifth step 98, a decision is made as to whether the model is calibrated based on whether the measured and calculated temperature profiles match. If they do not match, the variables of the model are iterated and temperature profiles recalculated until they do match. Step 102 permits iteration of the foregoing steps until all desired operational conditions have been simulated and correlated with the mathematical model.

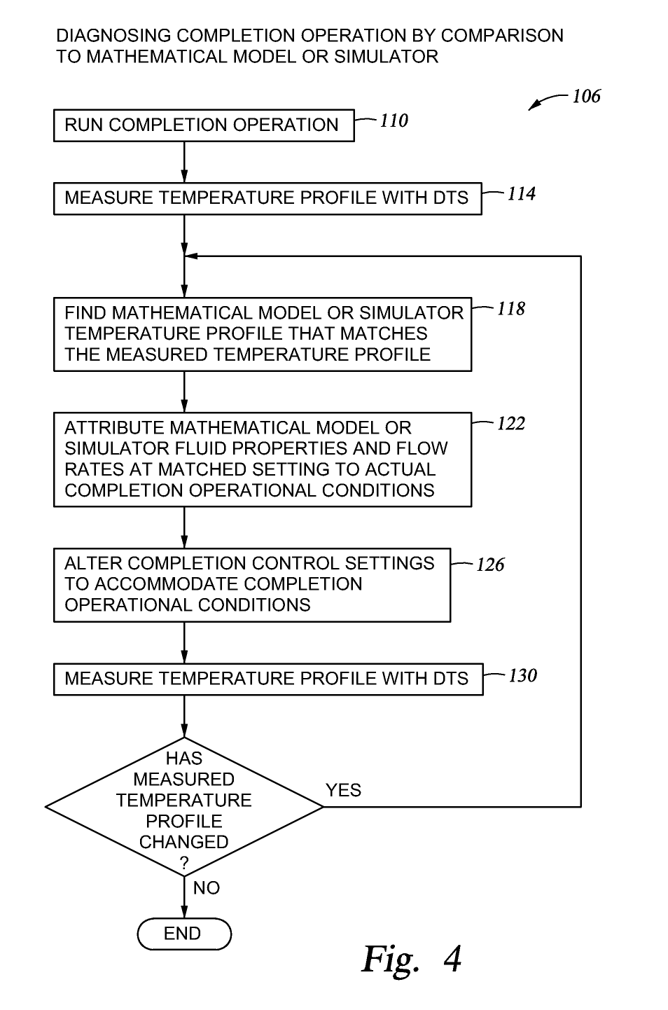

Referring to FIG. 4, a process for diagnosing a completion operation by comparison to the mathematical model or the simulator is shown by flow chart 106. In a first step 110 of the process the completion liner 10 is operated in a completion operation as schematically illustrated in FIG. 1. A temperature profile is measured with the DTS 30 in a second step 114. In a third step 118 the simulator is analyzed to find parameters that result in a matching temperature profile to that measured in the completion operation. Alternately, the model can be analyzed to find variables that result in a matching profile to that measured in the completion operation. A fourth step 122 attributes fluid properties and flow rates at matched settings from the model or simulator to actual completion operational conditions. With such knowledge the operator of the completion can perform the fifth step 126 and make adjustments to the completion, such as, through closure of valves, for example, to increase longevity of the completion and total production recoverable therefrom, as discussed above. Step six 130 allows the foregoing steps to be repeated over time as differences in the measured temperature profile change. Additionally, when changes to the measured temperature profile occur over time the process allows for diagnosing what has changed, i.e. fluid density, fluid viscosity, fluid oil to water to gas ratios or flow rates, so that appropriate corrective actions can be taken.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of diagnosing flow through an inflow control device:
producing or injecting fluid through an inflow control device;
measuring temperatures near or at the inflow control device over time while producing or injecting fluid therethrough; and
attributing temporal changes in temperature to changes in the fluid being produced or injected.

2. The method of diagnosing flow through an inflow control device of claim 1, wherein the measuring temperatures is with a distributed temperature sensor or a plurality of discrete thermal sensors.

3. The method of diagnosing flow through an inflow control device of claim 1, further comprising mapping flow characteristics versus actual temperatures of the inflow control device under controlled conditions

4. The method of diagnosing flow through an inflow control device of claim 3, further comprising:
comparing the measured temperatures to actual temperatures; and
attributing deviations between the measured temperatures and the actual temperatures to changes in the fluid.

5. The method of diagnosing flow through an inflow control device of claim 3, wherein the flow characteristics mapped include changes in ratios of oil to water to gas of the fluid.

6. The method of diagnosing flow through an inflow control device of claim 3, wherein the flow characteristics mapped include changes in fluid flow rates.

7. The method of diagnosing flow through an inflow control device of claim 3, calibrating a mathematical model to the mapping.

8. The method of diagnosing flow through an inflow control device of claim 1, further comprising mathematically modeling distributed temperatures to fluid properties.

9. The method of diagnosing flow through an inflow control device of claim 8, wherein the attributing is based on the mathematical modeling.

10. The method of diagnosing flow through an inflow control device of claim 1, further comprising altering an operational condition of the inflow control device.

11. The method of diagnosing flow through an inflow control device of claim 1, further comprising solving equations of mass, energy and momentum while iterating oil to water to gas ratios until results closely match newly measured temperatures.

12. The method of diagnosing flow through an inflow control device of claim 11, wherein the equations include Joule Thompson Effect equations.

13. The method of diagnosing flow through an inflow control device of claim 1, further comprising establishing a baseline temperature profile for specific fluid properties at a specific flow rate.

14. A method of determining compositional changes of a fluid flowing through an inflow control device comprising:
measuring temperatures at selected points relative to the inflow control device at a first time;
measuring temperatures at the selected points relative to the inflow control device at a second time;
determining differences in temperature at the selected points between the first time and the second time; and
attributing temporal temperature differences at the selected points to changes in composition of the fluid flowing.

15. The method of determining compositional changes of a fluid flowing through an inflow control device of claim 14, wherein the selected points include points upstream and points downstream of the inflow control device.

16. The method of determining compositional changes of a fluid flowing through an inflow control device of claim 14, further comprising attributing the temporal temperature differences at the selected points to a shift in ratios of oil to water to gas of the fluid flowing.

17. The method of determining compositional changes of a fluid flowing through an inflow control device of claim 16, further comprising determining a composite viscosity of the fluid flowing from the ratios of oil to water to gas of the fluid flowing.

18. The method of determining compositional changes of a fluid flowing through an inflow control device of claim 14, wherein the attributing the temporal temperature differences at the selected points to changes in composition of the fluid is based upon correlations to temperatures measured while known fluid compositions and flow rates were flowed through the inflow control device.

19. The method of determining compositional changes of a fluid flowing through an inflow control device of claim 14, further comprising:
measuring and/or calculating pressures at selected locations relative to the inflow control device at a first time;
measuring and/or calculating pressures at the selected locations relative to the inflow control device at a second time; and
comparing ratios of temporal changes in pressure at the selected locations to temporal changes in temperature at the selected points for the fluid flowing through the inflow control device to ratios of temporal changes in pressure at the selected locations to temporal changes in temperature at the selected points for fluid flowed through the inflow control device under controlled conditions.

20. The method of determining compositional changes of a fluid flowing through an inflow control device of claim 14, wherein the determining is performed while the inflow control device is functioning in a downhole completion application.
